(19) United States
(12) Patent Application Publication
(10) Pub. No.: US 2013/0207839 A1
(43) Pub. Date: Aug. 15, 2013

(54) Strong WWAN-WLAN Intermodulation (IM) Mitigation and Avoidance Techniques

(71) Applicant: QUALCOMM Incorporated, (US)

(72) Inventors: Emilija Milorad SIMIC, San Diego, CA (US); Timothy Paul PALS, San Diego, CA (US); Dominic Gerard FARMER, Los Gatos, CA (US)

(73) Assignee: QUALCOMM Incorporated, San Diego, CA (US)

(21) Appl. No.: 13/741,942

(22) Filed: Jan. 15, 2013

Related U.S. Application Data
(60) Provisional application No. 61/597,445, filed on Feb. 10, 2012.

(51) Int. Cl. G01S 19/21

(52) U.S. Cl. CPC G01S 19/21
USPC 342/357.59

(57) ABSTRACT

Apparatuses, methods, and computer-readable media for mitigating intermodulation (IM) distortion in wireless communications devices and systems are presented. Aspects of the present invention include several different techniques that can be used separately or in tandem. For example, a receiver mitigates IM distortion by altogether avoiding reception of satellites in a GNSS band(s) that are affected by it (e.g. “victim’ or “affected” band). A receiver may instead switch reception of satellites in a GNSS band that are affected by the IM distortion (e.g. the “victim” band) and not in a dedicated tracking mode, to another GNSS band that is not affected (e.g. “non-victim” band), while still maintaining tracking of satellites in the original victim GNSS band that are in a dedicated tracking mode. A receiver may also shift a local oscillator (LO) frequency. A receiver may also perform enhanced cross-correlation techniques, such a widening or expanding an existing Xcorr algorithm mask.

### CROSS REFERENCES TO RELATED APPLICATIONS

This application claims the benefit of U.S. Provisional Application 61/597,445, filed on Feb. 10, 2012, and titled “STRONG WWAN-WLAN INTERMODULATION (IM) MITIGATION AND AVOIDANCE TECHNIQUES,” the disclosures of which are incorporated herein by reference in their entirety and for all purposes.

### BACKGROUND OF THE INVENTION

A receiver attempting to use information provided by global navigation satellite systems (GNSS) may be subject to intermodulation (IM) distortion, which may create spurious readings or may render the receiver unable to perform its intended purpose. IM distortion power levels may vary, however, and may depend on a variety of factors. Because of the varying nature of IM distortion and its effects on receivers, traditional methods for countering the distortion effects, such as blanking or notching, may be ineffective. Thus, there may be a need to conduct new techniques for mitigating or avoiding IM distortion.

### SUMMARY

These problems and others may be solved according to embodiments of the present invention.

Apparatuses, methods, systems and computer-readable media for mitigating intermodulation (IM) distortion in wireless communications devices and systems are presented. IM distortion, which may be caused by an IM jammer, disrupts the normal reception of radio frequency (RF) signals in wireless devices. Herein, IM distortion and IM jammers may refer to each other interchangeably. The consequences of such distortion include inaccurate readings in global navigation satellite systems (GNSS), inaccurate determinations of particular GNSS satellites locations, reduced GNSS signal strength, and even complete signal blockage for entire GNSS systems for very strong IM jammers. Thus, implementing ways to mitigate, avoid, or counteract the effects of IM distortion is highly desirable.

By implementing aspects of the disclosure, a user of a wireless device may be able to substantially reduce the effects of IM distortion. Aspects of the present invention include several different techniques that can be used separately or in tandem. Each technique may be suitable for a different strength or a severity of IM distortion/jammer. In some embodiments, a receiver mitigates IM distortion by altogether avoiding reception of satellites in a GNSS band(s) that are affected by it (e.g. “victim’ or “affected” band). For example, a GNSS receiver that detects the presence of strong IM jammer in GLONASS band but not in GPS and Compass bands may switch from reception of satellites in all three bands GPS, Glonass and Compass to reception of satellites only in “unaffected” or “non-victim” bands GPS and Compass.

In some embodiments, a receiver mitigates IM distortion by switching reception of satellites in a GNSS band that are affected by the IM distortion (e.g. the “victim” band) and not in a dedicated tracking mode, to another GNSS band that is not affected (e.g. “non-victim” band), while still maintaining tracking of satellites in the original victim GNSS band that are in a dedicated tracking mode. For example, a receiver that detects the presence of strong IM distortion in the Global Positioning System (GPS) band may switch reception of satellites in GPS and not in a dedicated tracking mode to reception of satellites in the Global Navigation Satellite System (GLONASS) band. Thus, the receiver now tracks GPS satellites that are in dedicated tracking mode, plus satellites in the GLONASS band, regardless of whether they are in dedicated tracking mode.

In some embodiments, a receiver may shift a local oscillator (LO) frequency. Where the IM distortion is so strong that the IM distortion affects multiple GNSS bands via RSB image—for example, both GPS and GLONASS bands—and thereby disrupt both GNSS bands, shifting the LO frequency on a receiver may cause the IM distortion RSB image to no longer fall onto one of the GNSS bands. For example, for a very strong IM jammer that targets the GPS band, its RSB image may be strong enough to affect the GLONASS band as well. The GPS band is grossly affected by the IM distortion, while the GLONASS band is also affected, but only mildly because only the IM distortion image (which is typically much weaker) falls onto the GLONASS band. In this case, shifting the LO frequency of the receiver may change the location of the IM distortion RSB image relative to GLONASS band, such that the IM distortion RSB image no longer fall onto the GLONASS band. By doing so, the reception of the GLONASS band is free from IM distortion, and other remedial measures, including those described in the present disclosure, can be taken.

In some embodiments, a receiver may perform enhanced cross-correlation (Xcorr) techniques, such a widening or expanding an existing Xcorr algorithm mask.

In some embodiments, a GNSS receiver may go into an idle state in order to avoid IM distortion. When the presence of IM distortion is so strong that both its fundamental signal and its RSB image fall onto multiple GNSS bands or so wideband that it falls on all GNSS bands, there may be very little recourse but to revert to an idle state and wait until the strong distortion ceases.

In some embodiments, a system may comprise some or all of the aforementioned techniques into a multi-tiered system to mitigate IM distortion.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an exemplary apparatus of various embodiments of the present invention.

FIG. 2 is a graphical illustration of an example wireless network environment that can be employed in conjunction with the various systems and methods described herein.

FIG. 3 is an example scenario of IM distortion affecting a wireless communications system.

FIG. 4 is a chart showing the effects of IM distortion.

FIG. 5 is a graphical illustration of the effects of the RSB image in a GNSS receiver.

FIG. 6 is a chart showing the different levels of mitigation techniques of various embodiments of the present invention.

FIG. 7 is an example flowchart describing various IM mitigation techniques according to some embodiments.

FIG. 8 is an exemplary computer system of various embodiments of the present invention.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art.

Various embodiments are described herein in connection with an access terminal. An access terminal can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with access terminal(s) and can also be referred to as an access point, Node B, Evolved Node B (eNodeB), access point base station, or some other terminology.

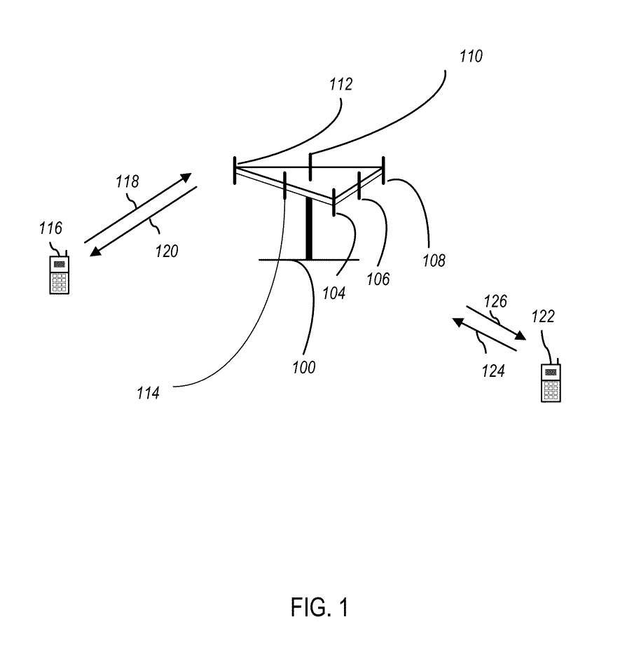

Referring to FIG. 1, a multiple access wireless communication system according to some embodiments is illustrated. An access point (AP) 100 includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In a Frequency Division Duplex (FDD) system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In the embodiment, antenna groups each are designed to communicate to access terminals in a sector of the areas covered by access point 100.

In communication over forward links 120 and 126, the transmitting antennas of access point 100 utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

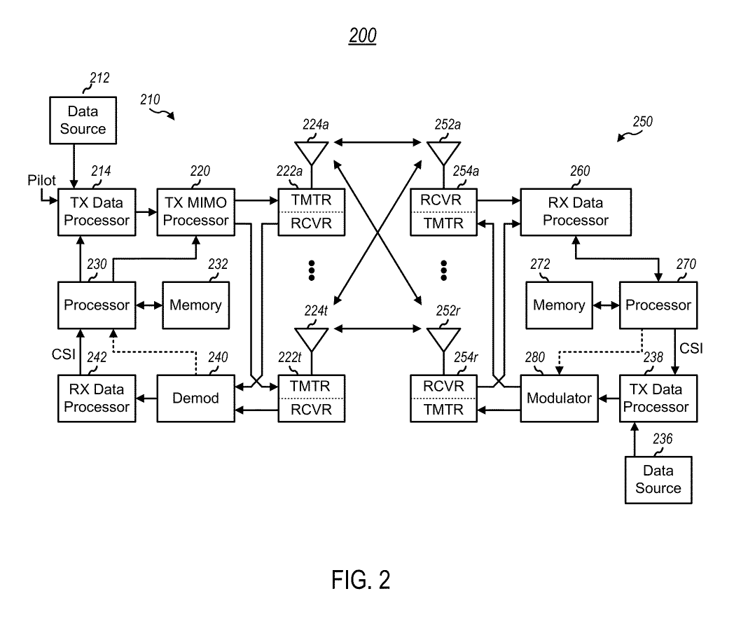

FIG. 2 is a block diagram of an embodiment of a transmitter system 210 (also known as the access point) and a receiver system 250 (also known as access terminal) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Apparatuses, methods, systems and computer-readable media for mitigating intermodulation (IM) distortion in wireless communications devices and systems are presented. IM distortion, often times transmitted by IM jammers, are signals that disrupt the normal reception of radio frequency (RF) signals in wireless devices. The consequences of such distortion include inaccurate readings in global navigation satellite systems (GNSS), inaccurate determinations of particular GNSS satellites locations, reduced wireless signal strength, and even complete signal blockage for entire GNSS systems for very strong IM jammers. Thus, implementing ways to mitigate, avoid, or counteract the effects of IM distortion is highly desirable.

By implementing aspects of the disclosure, a user of a wireless device may be able to substantially reduce the effects of IM distortion. Aspects of the present invention include several different techniques that can be used separately or in tandem. Each technique may be suitable for a different strength of IM distortion that may depend on the strength or severity of an IM jammer.

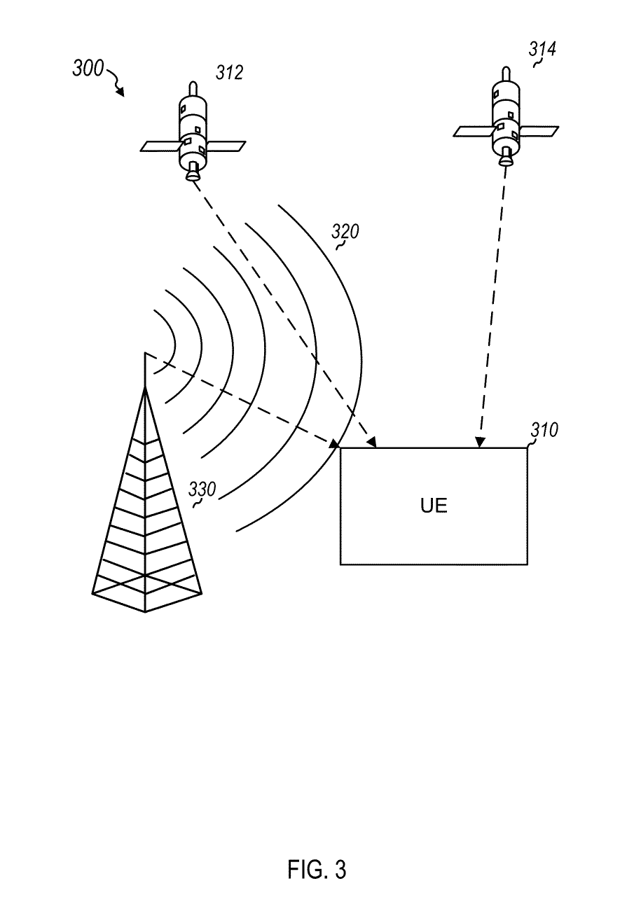

Referring to FIG. 3, User Equipment (UE) 310 is an exemplary apparatus of embodiments of the present invention, shown in diagram 300. UE 310 may receive signals from space vehicles (SVs) 312 and 314. SV 312 may be a part of a first GNSS constellation, for example the GPS band. SV 314 may be a part of a second GNSS constellation, for example the GLONASS band. While configured to receive signals from SVs 312 and 314, UE 310 may also experience IM distortion 320 transmitted by IM jammer 330. One example of IM distortion may be a second order and third order combination of a WWAN and WLAN signals both encountering a non-linearity, creating an inter-modulation product. In general, inter-modulation of transmitted signals of certain WWAN channels and certain WLAN radio technology channels may result in IM distortion falling into a GNSS band. A WWAN-WLAN IM jammer may be a wideband pulsed interferer with varying durations and periodicity. Additionally, IM jammer power levels may vary, and may depend on a variety of factors. These factors may include the degree of isolation between WWAN and WLAN TX antennas, and filtering in a GNSS RX front end. The power levels of IM distortion may be up to about −147 dBm-Hz currently. Because of the varying nature of these IM jammers, traditional methods for countering the jammer effects, such as blanking or notching, may be ineffective. Thus, in some embodiments, the effects of IM distortion 320 may be mitigated or avoided using novel techniques presented herein.

In some embodiments, a receiver 310 mitigates IM distortion by switching reception of satellites in a GNSS band that are affected by the IM distortion (e.g. the “victim” band) and not in a dedicated tracking mode, to another GNSS band that is not affected (e.g. “non-victim” band), while still maintaining tracking of satellites in the original victim GNSS band that are a dedicated tracking mode. For example, a receiver that detects the presence of strong IM distortion in the Global Positioning System (GPS) band may switch reception of satellites in GPS and not in a dedicated tracking mode to reception of satellites in the Global Navigation Satellite System (GLONASS) band. Thus, the receiver now tracks GPS satellites that are in dedicated tracking mode, plus satellites in the GLONASS band, regardless of whether they are in dedicated tracking mode.

In simplified terms, “dedicated tracking mode” may refer to tracking satellites whose position is known in the sky with a near certainty, even in the presence of IM distortion. At a more detailed level, satellites in dedicated tracking mode may refer to satellites whose position in the sky may be identifiable with 100% certainty even with only a single positioning scan. Thus, a satellite in dedicated tracking mode can still be relied upon for positioning data, even in the presence of IM distortion, because a scan at the satellite's last known location is highly reliable to yield accurate positioning data from that satellite, rather than spurious data coming from an IM jammer. In some embodiments, tracked satellites in dedicated tracking mode may be maintained, while all other tracking for satellites not in dedicated tracking mode may be switched over to a different GNSS band not affected by the jammer (i.e. a “non-victim” band). Benefits of not entirely switching over to the non-victim band may include more efficient power consumption, more efficient software implementation, and shorter latency from not having to switch over completely to a new GNSS band, as satellites already in dedicated tracking mode can still be relied on for position location determinations, subject to some constraints, described more below. A further description of dedicated tracking mode may be provided in more detail below.

More specifically, dedicated tracking mode first relies on all types of data observed about a satellite, e.g. either directly by previous measurements or from a receiver's knowledge of position, location and information about other space vehicles (SVs) coming from higher layers or a more northerly position engine. It may not matter where the information is obtained from, so long as the receiver has the information already about the particular SV. This may also mean that the uncertainty of the SV's position is so small that a receiver can actually observe it using even a small channel, the small channel including just one task in this case. Since tracking this particular SV has been done before, there is a high confidence that if observing something in the grid where the particular SV was tracked again is going to be this particular SV and not some sort of a false alarm or a jammer.

Because the total search space is small for SVs in dedicated tracking mode, it can be determined that attempting to locate these SVs are not in danger of being affected by the jammer in a sense of causing position outliers. Position outliers may be discussed more below. There may still be a defense of the IM jammer, but as long as the SVs position is known within one scanning window, IM distortion may have only minimal impact, if at all.

Expressed in other terms, in essence, saying an SV is dedicated means one can apply sufficient correlated resources to not have to time a sequence of operations on that particular satellite. In other words, the SV gets substantially 100% duty cycling, and substantially 100% observation all the time within a correlated space. For example, assume the scanning dimensions of the correlated space for the SV are N times M, N times M frequency, where N and M are arbitrary positive integers. If there are enough correlators to cover that N by M space for that particular satellite, that satellite essentially is now in a dedicated mode. It gets substantially 100% coverage, which brings about many advantages. For example, knowing with 100% or near 100% certainty the location of an SV with a single scan at a location in the sky allows a receiver to reliably scan exactly that space and trust that the signals received from that scan are from the dedicated SV, rather than a jammer or other interference data.

In some embodiments, a receiver may also perform a fast scan to detect additional RF sources on the horizon. For example, assume the receiver starts in receiving in the GPS band, and due to IM interference, the receiver needs to free up its resources in the GPS band and switch to GLONASS because the receiver is confident that it is going to be free of the jammer. Avoiding the jammer may be advantageous because not only may there be minimal position outliers, there may also be no defense when trying to defend against the jammer's effects without avoiding it. However, on the affected victim-band in this example, GPS, the receiver may keep the channel in dedicated mode and the receiver may also reserve a certain number of correlators whose only job may be to do a fast-scan for any unknown SVs and the visible SVs at the horizon. Over time, new SVs may arise in the sky just based on the normal rotation of the earth. Thus, in order to be highly confident that there are not any potential outliers due to the potential cross-correlating interference between multiple SVs, the receiver may run this fast scan to determine if any new SVs arise in the sky. In some embodiments, this fast scan has a duration of or about one second.

There are several reasons for conducting this fast scan, some as already mentioned. For example, again assume that the receiver has switched most reception to a non-victim band, but kept some channels on the victim band in dedicated mode, which is potentially affected by a jammer. A defense is expected for the ones that are all in a dedicated queue, but the receiver also wants to make sure that, if newly SVs rise on the horizon that are strong and that are now becoming visible and previously they were not, these new rising SVs can cause the cross-correlation interference. Normally that would not be a problem because there are cross-corn mechanisms in place to counteract these effects, but conventional methods may be insufficient in the presence of IM distortion from a jammer. One reason may be because the IM distortion from the jammer can appear and reappear anytime without warning. One adverse effect of IM distortion in this case is that, if connection is swamped, for very shallow searches at the horizon, newly risen cross-corn sources may not be observed. If the receiver does not observe the new source, then there is know way to know about it. Subsequently, the receiver will not be able to use it in conventional cross-correlation algorithms to protect against the cross-corn outliers. Cross-correlation algorithms are discussed in more detail below. By adding this additional search, one make help make sure that in these dedicated searches that in the last second of them, they were free of any of these newly visible SVs in the last second. It is an additional protection to make sure that the dedicated searches that are being allowed on the victim band, are going to be completely a position outlier.

As alluded to above, on a “victim” GNSS band a fast search/scan may need to be performed to search for potential Xcorr sources and enhanced Xcorr mitigation algorithms to ensure that satellites in dedicated tracking mode are not Xcorrs rather than valid signals. Potential Xcorr sources may be strong visible SVs with large uncertainty (e.g. uncertainty in position, frequency, time uncertainty, and number of search tasks needed) and strong unknown SVs (e.g. unknown in the sense that the SV was unseen, now becomes seen; was below horizon, now above horizon, etc.), with total duration for this fast search <1 second. Enhanced Xcorr mitigation algorithms may include, depending on the IM jammer strength, widening the existing Xcor masks, as well as additional check for IM jammer related Xcorr, in conjunction to running fast search for visible SVs with large uncertainty and unknown SVs. If the last second of a search is IM jammer event free, the measurement is deemed to be safe, subject to a positive outcome of the regular Xcorr algorithms. These Xcorr algorithms may be discussed in more detail below.

At a high level, “cross correlation algorithms,” or “Xcorr algorithms” for short, are procedures, steps, or programs that reduce the effects of cross-correlation interference. Cross-correlation interference arises when multiple SVs in the sky are observed by a target receiver, and said receiver has difficulty identifying and determining accurate data from each individual SV. GPS signals in their essence have a code that repeat themselves. This code is not to be confused with gold codes, in that they are not maximum line codes, and they are not completely random. They are pseudo-random. So as a result, when cross correlating one SV with another SV code, the resulting product may create what are called cross correlations, which may be thought of peaks that look like the normal peaks due to the normal regular satellite. Their signal signatures may be down significantly, compared to normal peaks associated with a single SV pseudorandom (PRN) code, e.g. about 20 decibels (dB) down from the normal peaks.

However, if the receiver is in a “partially blocked environment”—meaning IM distortion is blocking or interfering with reception of some SVs while others are unaffected—the receiver may observe signals from a strong SV and very weak SV. When the strong SV and the very weak SV get cross-correlated against each other, then the cross-corns, due to the strong SV which may be 21 dB down from normal peaks, can still be stronger than the weak SV. Thus, one may erroneously think that a cross-corn peak may be the normal peak due to the signal when it is in fact not; it is actually due to the cross-correlation just with the strong SV. One detrimental effect is it can trick a position engine potentially into steering towards potentially a wrong code phase or a wrong Doppler reading which may definitely degrade your position accuracy. Such misreads may be called position outliers.

As such, cross-correlating without a cross-corr algorithm due to the presence of a jammer can create false positives. Additionally, the false positives may show up as stronger than even the real signal; so the real information may be disregarded in favor of a false one. This is what may be referred to as a false alarm. Thought of another way, say there is a composite signal coming at the receiver from the observed sky. In the sky there may be, at any given point of a surface scan, for example 16 satellites may be seen. And all these 16 signals, due to you having 16 satellites, have their own gold codes. From the receiver's perspective, a local copy of the code of a target satellite in question may be generated. Assume the receiver is interested in satellite 6. The composite signal the receiver picks up may have the code of multiple satellites, e.g. a signal 6 and 10 and 12 and 15 and 11, etc. So when the receiver perform correlating functions, even though the receiver is originally intending to correlate of the receiver's local copy of code 6 versus the code 6 coming from the satellite in order to determine information about the distance to satellite 6, which results in this arranged measurement message, the receiver also ends up correlating against the multiple other SVs in the sky. And because the codes are not perfect, they may have a cross correlation. Ideally, the cross-correlation product the codes of a satellite 16 versus the code of 6 should result in nothing; that would be ideal results. In other words, obtaining a cross-correlation product of codes, e.g. satellite 16 with code of satellite 6 with a resulting product of null would ideally signal that the receiver is observing satellite 16 rather than satellite 6. But unfortunately, because the codes are not perfect, a peak may result. So even when you cross-correlate the local copy of 6 versus 16, even a small peak may result, which is not the desired ideal result and must be resolved. Ideally, the correct result should be a peak results only when cross-correlating local codes of SV 6 with the incoming SV 6.

Viewed another way, suppose for example a signal from SV 16 is very strong, and a signal from SV 6 is small, due to say being in a partially blocked environment, i.e. there is a direct line of sight to 16 but there are refractions to 6. Suppose the receiver is able to observe enough of the sky to see both of them. Upon the receiver performing correlation functions using the local code 6 versus code 16 and code 6, the result may be two peaks. One is due to what the receiver was originally were trying to observe, i.e., SV 6. However, since SV 6 provides a weak signal because it is just a refraction, the receiver correlating function will generate a cross-correlation due to the imperfect property of the codes between SV 6 and SV 16 which is very strong because 16 is within a direct line of sight. This result is a problem because the receiver was actually looking for SV 6, not SV 16. Thus, the receiver may erroneously think that it has identified a signal from SV 6, but actually it is SV 16. This is an example of a false alarm. And as the resulting that two cross-range measurement message having a potentially wrong cross-phase, potentially wrong Doppler and they both contributed to the accuracy of the position solution.

Based on even just these few examples, it may be apparent that when there is a strong jammer present, many mechanisms and functions typically utilizing satellite signals may be rendered inaccurate or even completely unreliable. The jammer can confuse readings and false information, sometimes even resulting in new SVs in the sky being undetected and causing further confusion. The cross-correlation algorithms work as long as they are aware of the SVs they need to check for cross-correlation. If the receiver does not even detect the presence of new satellites due to the IM distortion, then the receiver has no chance of protecting itself against the interference that it does not know about. Thus, the methods described herein are essential to protecting against the deleterious effects of IM jammers.

Additionally, there are other advantages for performing fast scan of the horizon. For example, if the IM jammer distortion disappears and reappears on its own, while searching for a strong SV 16 but not for the weak 6, then this can cause trouble for the receiver. Such behavior is a common characteristic of sophisticated jammers, and are some of the types that embodiments of the present invention are meant to defend against. Such a mechanism can actually interfere with existing cross-corr algorithms to the point where the receiver is exposed; as if the receiver did not even have a cross-corr algorithm.

In order to avoid these problems, e.g. in order to still operate in the band affected by the jammer, and/or be sure to counteract the situations described above, some embodiments include a cross-correlate bank of tasks, whose job is to do a fast search for all the visible rising and unknown SVs and report back to the receiver. If that report is performed within a fraction of the time of the search, e.g. a one-second cadence of this search, and if that report is clean of any jammer effects, then it can be known, determined and trusted that the receiver is safe from the cross-corn error. In other words, in some embodiments, a fast search will be performed in the victim band to search for additional cross-corn sources. The potential cross-corr sources may come from newly risen satellites on the horizon, or may come from any known satellites possessing a large uncertainty. After having identified the sources, cross-corr algorithms may be performed to determine whether these sources cause interference or not. If the sources are determined to be safe, then the dedicated measurements that may be obtained from the victim (i.e. jammer affected) channel can be trusted not to be any position outliers but to be a real measurement.

Some embodiments include performing the fast scan as described above, and then determining whether any of the new sources identified by the fast scan may be unreliable. Described herein is an exemplary implementation for performing such a fast scan and cross-corn determination using an activity pin. Adding an activity pin may provide information as to whether there was actually a wireless LAN transmission. A process according to some embodiments may compare the activity pin with a combo wireless WAN and wireless LAN that is currently being transmitted in, in order to determine whether there was no jammer. The wireless LAN activity pin may be provided by a third party wireless LAN modem. And if it was integrated solution provided from the receiver's own wireless LAN. The activity pin may go high every time the receiver is transmitting. There also may be a software message that says which channel is being transmitted on, and since it is known which wireless LAN channel is being transmitting on, if at all, then it may be known if the receiver is transmitting on a combo of wireless WAN and wireless LAN channels that can result in intermodulation distortion. If any of those occurrences on that wireless activity pin happen in the last second, the results may not be trusted. However, if the occurrences happened prior to the last second, this may suggest that this one second measurement of the full sky really did yield all the potential cross-corn sources at the moment.

In summary, an exemplary process for detecting cross-corn sources using the activity pin may be as follows. The activity pin may be connected to an external WLAN activity signal, which may be provided by WLAN transmission. First, GNSS software may detect any occurrence of a WLAN activity signal going TRUE for a predetermined period, e.g. 20 ms. In some embodiments, this monitoring may occur without causing excessive interrupts, using software methods apparent to those with skill in the art. Then, an IM jamming event may be determined, using an IM jamming session indicator. The IM jamming session indicator may require one or more of the following conditions to be true in order to determine that an IM jamming event has occurred:
WLAN connection is signaled using QMI
WWAN is transmitting on “aggressor” channel
NV item “IM jammer power” for current WWAN Tx antenna is NOT 0
   In some embodiments, the activity pin may perform this determination by examining the sources identified within the last one second of a fast scan. In some embodiments, the fast scan may last twelve seconds, for example. Thus, if in the last second of the fast scan, no cross-corn sources have been identified, then the remaining satellites in dedicated tracking mode on the victim band may be deemed to be acceptable for assisting in position location determinations.

However, knowing of cross-corn sources using the methods described above, and knowing normal measurements on the dedicated search, a cross-corr algorithm may be conducted. Again, a purpose to conducting the cross-corn algorithm is to verify the presence of any unknown sources as well as if there are known sources but which are not visible, e.g. the sources are not above a threshold of an altitude map. If the sources are not visible, they are determined to not really affect signal processing at the receiver. However, if the sources are newly risen, then that means the receiver can see them and potentially the receiver can see them with a very strong signal. A version of this scan is normally done on a regular basis, but the adding of the activity pin is a novel feature according to some embodiments. This can help determine the presence of this wireless LAN transmission, which can result in determination of the use of an IM jammer.

Due to varying signal strength of the jammer, there is a need for varying IM distortion mitigation techniques. When the above certain power levels of the jammer, this mechanism won't necessarily work that well anymore. And the reason is actually due to the realities of the implementation of the receivers. For example, different receivers may have different levels of inphase/quadrature (I-Q) phase, amplitude, and balance. Therefore, every received signal has its own image, what may be called a residual sideband (RSB) image. Gravely attenuated, the RSB is the mirror frequency, gravely attenuated, but still present. Gravely attenuated may mean anywhere from 20-30 dBC, or dB below the main signal in the typical receivers.

The attenuation could be higher if doing IM calibration per device on the factory test floor, but this is intended to be avoided. Without some specialized factory test floor calibration, typical measurements for IM calibration may be at least high 20s, low 30s dB below the main signal.

What this may mean is that, if the jammer becomes very strong, at some point, some of the distortion may bleed into the mirror image due to this I/Q misbalance, even though originally, the distortion falls only on one victim band, e.g. the GPS band or GLONASS band. Additionally, some receivers may down-convert both GLONASS and GPS and by tuning the center frequency, i.e. the local oscillator (LO) frequency, in the center between the GPS and GLONASS bands.

The consequence of IQ imbalance is that the image of the GLONASS band is going to be in GPS band, and the image of the GPS is going to be in the GLONASS band. This may not normally a problem for the signals in discussion here because these signals are 20-30 dB below the normal signals. However, in the presence of an extremely strong jammer, then even 20 dB down or 30 dB down from that strong jammer might still be sufficient in energy and power to be, to some extent impede the receiver.

Thus, in the case of even stronger IM jammers, the above techniques may not be sufficient for fully overcoming the effects of IM distortion. This applies both in terms of potential for position outliers, the impeding with a normal cross-corn algorithms as well as a defense. Here, in the presence of the RSB, meaning if the jammer is so strong that RSB's now starting to matter, there now may no longer be unaffected bands. In other words, there is now a case of one grossly affected band and one mildly affected band.

Now because of the GPS's image RSB, some of that energy 20-30 dB down is going to leak from the GPS band into GLONASS, or conversely leak from GLONASS into the GPS band. While the GPS is still the main victim band because its grossly affected and then your GLONASS becomes also mildly affected, meaning affected minus 20 to 30 DB.

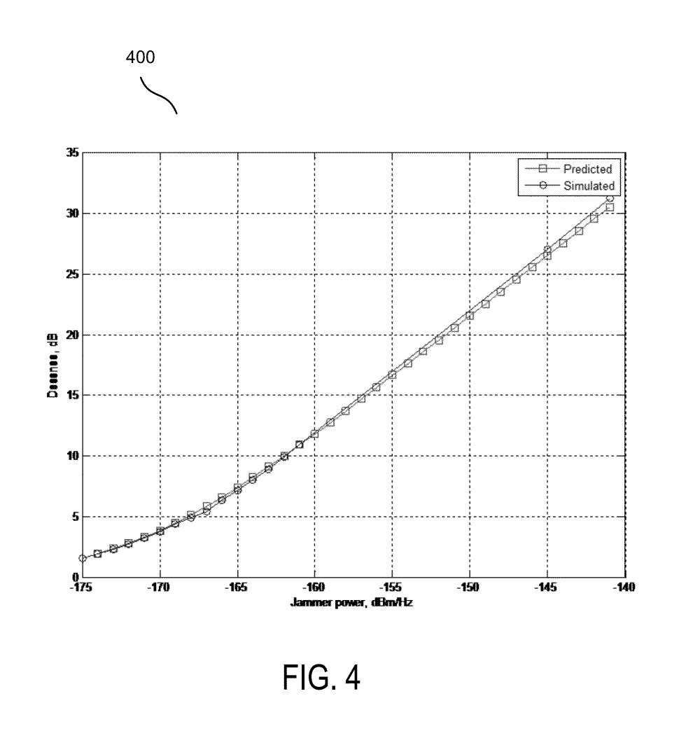

Referring to FIG. 4, the chart 400 illustrates a simulated and predicted rate of distortion, in dB, per level of Jammer power, measured in dBmHz. At varying levels, some mitigation techniques will be more effective than others, thus there may be a need to employ multiple mitigation techniques in the same wireless device.

Amplitude and phase I/Q imbalance may cause interference in one band, e.g. the GPS band, to generate weaker interference (a residual sideband image) in another band, e.g. GLONASS band, or vice versa. This is shown in FIG. 4. These show simulated ADC output spectra with 12 degrees of phase imbalance. On the left the input is thermal noise only. On the right a −100 dBm tone is applied at 1575.42 MHz, creating an RSB image tone with power −121 dBm in GLO band.

Therefore, in some embodiments, a receiver may shift a local oscillator (LO) frequency. Where the IM distortion is so strong that the IM distortion signal image reflects onto multiple GNSS bands—for example, both GPS and GLONASS bands—and thereby disrupt both GNSS bands, shifting the LO frequency on a receiver may cause the IM distortion signal image to no longer fall onto one of the GNSS bands. For example, for a stronger IM jammer that targets the GPS band, its image may reflect onto the GLONASS band as well. The GPS band is grossly affected by the IM distortion, while the GLONASS band is also affected, but only mildly because only the IM distortion image falls onto the GLONASS band. In this case, shifting the LO frequency of the receiver may change the location of the IM distortion reflections, such that the IM distortion reflections no longer fall onto the GLONASS band. By doing so, the reception of the GLONASS band is free from distortion, and other remedial measures, including those described in the present disclosure, can be taken.

Another novel aspect of the present invention may involve changing the frequency planning of the LO, meaning move it somewhere else in frequency such that the RSB image is no longer falling on the opposite band. Recall that the RSB image is at the mirror frequency of an original band. If the LO frequency of the receiver is centered between the two GNSS bands—define the center as zero—this is where the LO frequency may originally reside, then the GLONASS band is going to be roughly plus 13 MHz, the GPS is going to be roughly minus 13 MHz. Thus, the image of the GPS band is going to be falling on the mirror frequency, which means+13 and that's where GLONASS is and vice versa.

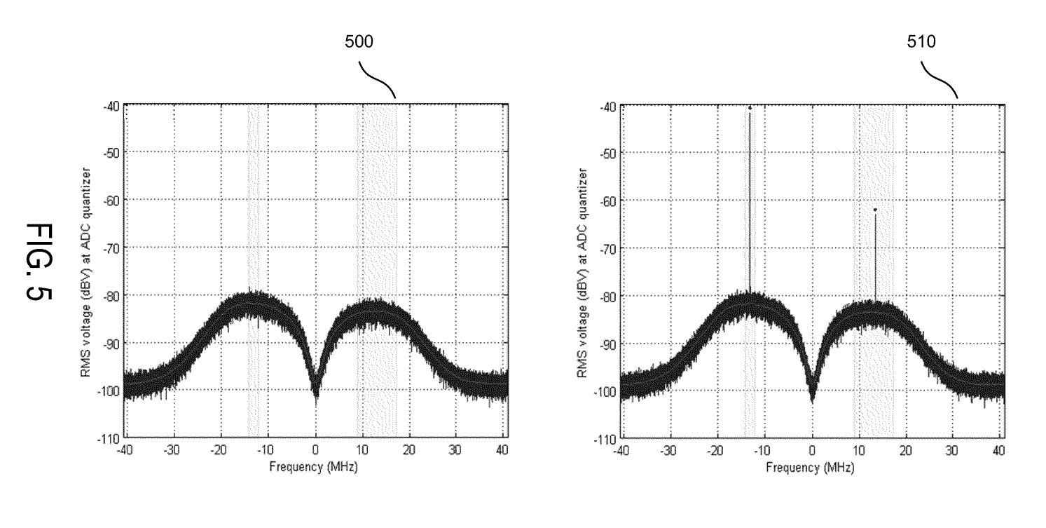

Referring to FIG. 5, the exemplary graphs 500 and 501 illustrate the concept of the LO frequency being centered between two GNSS bands, in this case GPS and GLONASS bands. It should be apparent that the mirror image reflections of one band will very closely match the frequency signature of the other band. Thus, if the jammer is sufficiently strong, distortion reflections affecting one band may spill over to the other band on the opposite side, causing distortion there as well.

Thus, if one changes the LO frequency, either up or down, such that the image of GLONASS no longer falls on GPS or the image of GPS no longer falls on GLONASS, then the result is to be back to the same problem as above, specifically that only one band is affected by the distortion. This technique thus allows a receiver to employ the previous techniques mentioned above in order to mitigate the IM distortion.

In some embodiments, a receiver may go into an idle state in order to avoid IM distortion. When the presence of IM distortion is so strong that both its fundamental signal and its reflection fall onto multiple GNSS bands, there may be very little recourse but to revert to an idle state and wait until the strong distortion dissipates.

In some embodiments, a system may comprise at least all three techniques described above, configured in a multi-tiered IM jammer mitigation system that employs an appropriate technique depending on how strong the IM distortion is. For example, for IM distortion<a first threshold (in dBM/Hz), no mitigation algorithms may be necessary. For IM distortion<a second threshold, major GNSS SW changes are necessary such as switching the receiver to the non-victim GNSS band while maintaining reception of the victim satellites in dedicated tracking mode. At this stage, some steps of the present invention may include:
Unconditionally disable DPO
Implement enhanced GNSS Xcorr (cross-corn) mitigation on victim band
   IM jammer related Xcorr check
Switch mostly to non-victim band
   Expect for dedicated jobs and fast scan queues on victim band
Ensure position fixes are done using measurements from
   Unaffected GNSS system, that are passing regular Xcorr mitigation tests
   Affected band, but only from dedicated tracking that are passing enhanced Xcorr mitigation test

For IM jammers<a third threshold, in some embodiments, if intermittent jamming is very strong, such that the desense caused by that jammer is more than 3 dB, then cross-corn mask expansion alone may not completely solve cross-corr false alarms. With this magnitude of desense, we may fail to acquire an SV that is a cross-corr source. The source SV must be detected for the cross-corn mask to have any value. The cross-corn source is a strong SV, expected to be detected by a shallow search. But if the jamming is present during that search it is not detected. The undetected source SV can generate a cross-corn peak strong enough to be detected by a deep search for another SV, if the jamming is not present during that deep search. This possibility can be eliminated by an additional C/No check. Given a desense level, estimate the power of the strongest source SV that can fail to be detected. Calculate the C/No of the worst-case cross-corr peak generated by that source SV. Reject any measurement below that C/No threshold. The cross-corn mask must also be expanded beyond 3 dB. The expansion amount depends on the desense level. In some embodiments, de-sense due to the IM jammer is expected to follow this equation:

De-sense[dB]˜10*log(1+10̂((J−N)/10)) (1)

Where J=NV item value (dBm/Hz) for IM jammer, and N=−171 dBm/Hz (assuming baseline GPS NF of 3 dB). The Xcorr/ACI mask expansion needed is equal to de-sense (dB)−1.5 dB. In some embodiments, existing Xcorr/ACI masks have 1.5 dB built-in margin. GPS Xcorr C/No threshold may be set at deepest mode sensitivity (12 dB-Hz)+de-sense (dB).

For IM jammers<a fourth threshold, GNSS SW may implement the same IM jammer avoidance algorithms as for IM jammers up to the second or third threshold. Exceptions may include for enhanced Xcorr algorithms on a victim band now also include widening of Xcorr masks.

For IM distortion<a fifth threshold, shifting the LO frequency of the receiver may be necessary. Some characteristics of embodiments of the invention at this level may include:
This is IM jammer power level X, where even the non-victim band starts getting affected via receiver RSB
On this non-victimless affected band, GNSS SW to check if W<S condition is satisfied at the beginning of, and then periodically throughout the IM jamming session
If satisfied, GNSS SW to perform the same IM jammer avoidance algorithms as for jammers up to a sixth threshold, except enhanced Xcorr mitigation algorithms now implemented on both bands
Otherwise, GNSS receiver may be forced to idle state

For IM distortion>seventh threshold, the GNSS receiver may be forced to idle state.

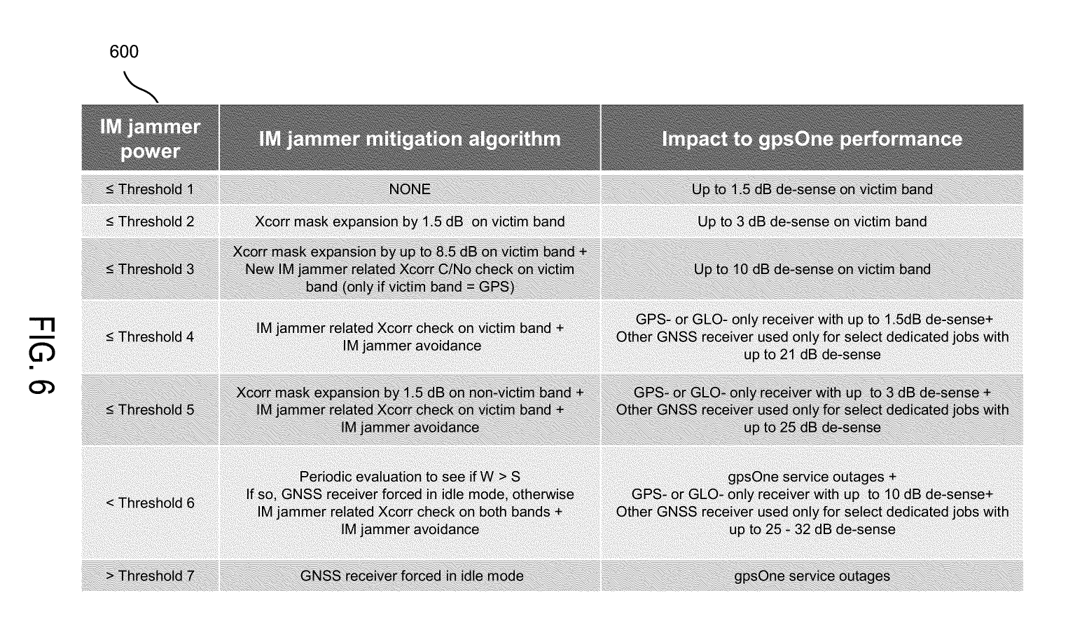

FIG. 6 illustrates a chart 600 that summarizes some of the techniques described in the present invention, for varying levels of IM distortion. These techniques are described above and summarized herein, according to a series of thresholds, where each threshold illustrates a progressively stronger level of distortion. To summarize again, for IM jammer power less than or equal to a first threshold, the jamming power may be sufficiently minimal to where no IM jammer mitigation techniques may be necessary. Going up a next level, for IM jammer power less than or equal to a second threshold, the Xcorr mask may be expanded by 3 dB on the victim band, so as to increase power to detect Xcorr sources to compensate for IM jammer effects.

At a high level, “widening a Xcorr mask” relates to procedures, steps, or programs that reduce a greater amount of uncertainty when attempting to distinguish an SV from spurious other signals. As a brief background, each satellite transmits its own code, and that code may be copied locally at a base station or other terrestrial source. Each code has non-zero Xcorr properties. When trying to acquire an SV, a peak may result from the SV being observed. The Xcorr properties can then be calculated. If the peak value of the SV is above a certain threshold, it can be determined that it is not a Xcorr source. However, for those below that threshold, it could be an SV or not. If the locally generated copy is not quite the same as the incoming signal, a Xcorr signal should result if detecting a different SV from the one that the local copy is based on. With that said, Xcorr masks are look up tables entries of Xcorr sources. Xcorr signals are sent to a Xcorr database containing these look up table entries, and an algorithm is used to check if the sources are consistent with any of the Xcorr properties. Therefore, widening a Xcorr mask refers to disregarding a wider range of uncertainty of the Xcorr signals.

For IM jammer power less than or equal to a third threshold, the Xorr mask may expand by up to 8.5 dB on the victim band, and also a new IM jammer related Xcorr C/No check may be performed on the victim band. For IM jammer power less than or equal to a fourth threshold, embodiments may perform IM jammer related Xcorr checks on the victim band as well as avoid the IM jammer effects by switching to a non-victim band for any satellite sources not in a dedicated tracking mode. For IM jammer power less than or equal to a fifth threshold, the techniques of the previous two levels may be combined together. For IM jammer power less than or equal to a sixth threshold, there may be periodic evaluation to see if W>S, where W=total search space uncertainty, and S=actual capacity of the searcher. In some embodiments the actual capacity of the searcher may be on the order of 90 tasks. If so, then the GNSS receiver may be forced into idle mode. If W<S, then the techniques described above may be applied to two GNSS bands, not just the original victim band. At IM jammer power this strong, there may be some spill over to the originally non-affect band, to where now both bands are affected, and mitigation techniques should be applied to both. In these instances, if the LO frequency is centered directly in between both bands, the LO frequency may be shifted so that the RSB image of the victim band may not spill over directly onto the originally non-affected band. Once the LO frequency is shifted, other mitigation techniques described herein may be used as normal. At IM jammer power beyond a seventh threshold, the GNSS receiver may be forced into idle mode.

In addition to a hardware implementation receiver that can receive two bands and switch upon command, software exemplary implementations are possible with embodiments of the present invention. For example, let's say you had GPS only receiver, meaning you had a, you know, maybe a relatively narrow bandwidth, and you knew you had a IM2 product in the GPS band, if you had sufficient software flexibility, perhaps in such a receiver you could reaching your LO and then position GLONASS in that tests baseband and process GLONASS instead of GPS.

In another software implementation, GNSS SW may perform the following actions during IM jamming mitigation session:
Calculate where IM jammer lands (GPS or GLONASS band)
Implement enhanced GNSS Xcorr mitigation on affected band(s)
Use enhanced GNSS Xcorr mitigation on affected band(s) to ensure only valid measurements from affected band(s) are used in position location
Ensure position fixes are computed using only valid measurements
   Where valid measurements are observation of real SV signals
      [symbol] Measurements on affected band(s) that are passing enhanced Xcorr mitigation
      [symbol] Measurement on unaffected band, if any, that are passing regular Xcorr tests

The following is a further description of some IM jammers that relate to the present invention. Inter-modulation of transmitted signals of certain WWAN channels and certain WLAN radio technology channels results in IM jammer falling into GNSS band. Further descriptions may include:
WWAN-WLAN IM jammer is wideband pulsed interferer with varying durations and periodicity
   Rendering traditional jammer methods ineffective, such as blanking or notching
IM jammer power level may depend on many platform factors
   Isolation between WWAN and WLAN TX antennas
   Filtering in GNSS RX front end
Power levels of up to ˜−147 dBm-Hz are expected on wireless device form factors today
IM jammer (up to certain power level X) never covers both GPS and GLO bands simultaneously
No 40 MHz 802.11n in 2.4 GHz band
IM jammer with 802.11b can fall in both bands simultaneously; sufficiently fast power spectrum roll off is assumed
IM jammer above power level X starts affecting both bands due to GNSS receiver RSB (please see Appendix)
Originally unaffected “non-victim” band is still affected much less
De-sense on less affected band is RSB (dB) less than desense on affected band

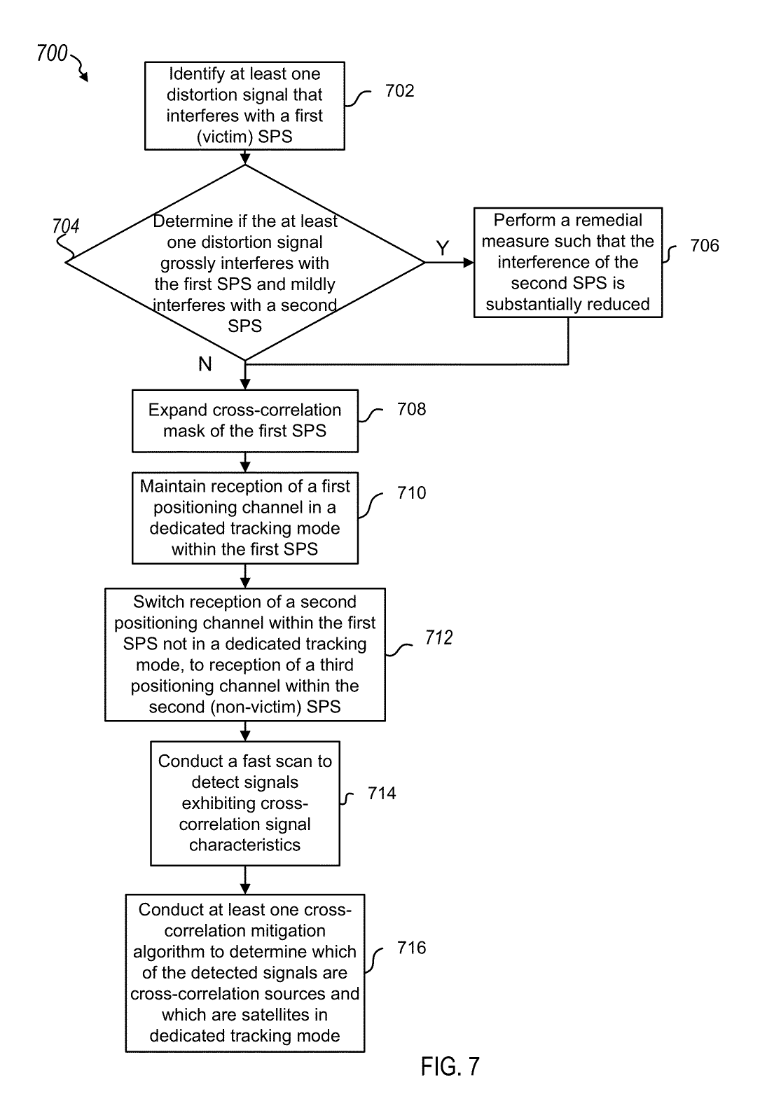

Referring to FIG. 7, the example flowchart 700 may describe the various techniques according to some embodiments. These techniques may summarize the more detailed descriptions of the various mitigation techniques described throughout the present disclosures. At block 702, a receiver may identify at least one distortion signal that interferes with a first satellite positioning system (SPS). Example SPSs may be GPS, GLONASS, and the like. The distortion signal may be IM distortion, consistent with the descriptions herein. The first SPS, being subject to the distortion, may be designated as the victim SPS, and thus may have characteristics consistent with the victim SPSs described throughout these disclosures.

At block 704, the receiver may determine if the at least one distortion signal grossly interferes with the first SPS as well as mildly interferes with a second SPS. A circumstance where this may be true is when the IM distortion is extremely strong, causing a spillover from the main victim band to a second band. These descriptions may be consistent with those above related to grossly affected and mildly affected bands due to IM distortion. If this is the case, then at block 706, the receiver may perform a remedial measure such that the interference of the second SPS is substantially reduced or eliminated altogether. An example of a remedial measure is to shift the LO frequency away from a center point of the first and second SPSs. As discussed above, such a remedial measure may move the residual sideband image of the grossly affected band away from the second band, allowing the second band to have substantially reduced or altogether eliminated distortion effects.

At block 708, if the second SPS is not affected, or if the second SPS has the distortion substantially reduced, then the receiver may first expand a cross-correlation mask of the first SPS in order to counteract the IM distortion effects in an attempt to maintain reception of positioning channels within the first SPS. Block 708 may be useful for counteracting the effects of IM distortion if the IM distortion is only mild or not very strong. In other cases, the IM distortion may be stronger, and block 708 may be performed as part of a multi-tiered approach to mitigate the IM distortion effects.

At block 710, the receiver may then maintain reception of a first positioning channel in a dedicated tracking mode within the first SPS. Descriptions of being in dedicated tracking mode may be consistent with those described throughout these disclosures. An example positioning channel may be a satellite within the SPS. As mentioned above, some benefits for maintaining reception of a positioning channel in dedicated tracking mode may include reducing software/processing burdens, and reducing latency from not having to completely switch over to the second SPS. Additionally, since the first positioning channel is in a dedicated tracking mode, the first positioning channel may be relied upon for position location determinations even in the presence of the distortion.

At block 712, the receiver may then switch reception of a second positioning channel within the first SPS, to reception of a third positioning channel within the second SPS. In some embodiments, the second positioning channel is not in a dedicated tracking mode, and may thus be subject to interference from the IM distortion unless it is switched over. In some embodiments, the second SPS may be referred to as the non-victim SPS or band, and thus may have characteristics consistent with the descriptions of non-victim SPSs described through these disclosures. Therefore, in some embodiments, IM jammer mitigation may include only partially switching over to a non-victim SPS, as opposed to completely switching over. Certainly, more than one positioning channel may be switched over, as the descriptions herein are merely exemplary.

At block 714, the receiver may conduct a fast scan to detect signals exhibiting cross-correlation signal characteristics. The fast scan or search may be consistent with those descriptions of a fast scan or search explained throughout these disclosures. The cross-correlation signal characteristics may be consistent with the discussions related to cross-corn interference throughout these disclosures. In some embodiments, this fast scan is conducted only on the victim SPS or band. One purpose for conducting the fast scan to detect for such signals may be to help ensure that the positioning channels in dedicated tracking mode are reliable and not subject to cross-correlation intereference.

At block 716, the receiver may then conduct at least one cross-correlation mitigation algorithm to determine which of the detected signals are cross-correlation sources and which are satellites in dedicated tracking mode. Examples and descriptions of cross-correlation mitigation algorithms may be consistent with those described throughout these disclosures.

As described above in FIG. 6, the example steps in FIG. 7 may not all need to be performed, and may depend on a power level of the IM distortion. Thus, a multi-tiered defense against IM distortion may be used that incorporates some or all of the techniques described herein, and embodiments are not so limited.

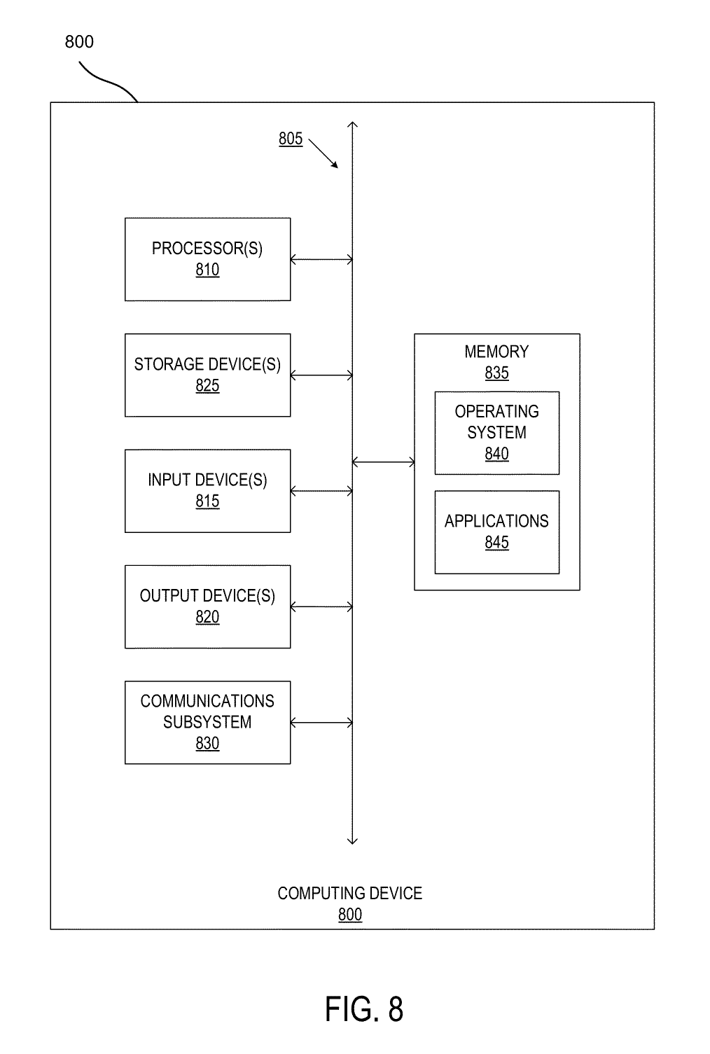

Having described multiple aspects of techniques for mitigating IM distortion on one or more GNSS bands, an example of a computing system in which various aspects of the disclosure may be implemented may now be described with respect to FIG. 8. According to one or more aspects, a computer system as illustrated in FIG. 8 may be incorporated as part of a computing device, which may implement, perform, and/or execute any and/or all of the features, methods, and/or method steps described herein. For example, computer system 800 may represent some of the components of a hand-held device. A hand-held device may be any computing device with an input sensory unit, such as a camera and/or a display unit. Examples of a hand-held device include but are not limited to video game consoles, tablets, smart phones, and mobile devices. In one embodiment, the system 800 is configured to implement the device 200 described above. FIG. 8 provides a schematic illustration of one embodiment of a computer system 800 that can perform the methods provided by various other embodiments, as described herein, and/or can function as the host computer system, a remote kiosk/terminal, a point-of-sale device, a mobile device, a set-top box, and/or a computer system. FIG. 8 is meant only to provide a generalized illustration of various components, any and/or all of which may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805 (or may otherwise be in communication, as appropriate). The hardware elements may include one or more processors 810, including without limitation one or more general-purpose processors and/or one or more special-purpose processors (such as digital signal processing chips, graphics acceleration processors, and/or the like); one or more input devices 815, which can include without limitation a camera, a mouse, a keyboard and/or the like; and one or more output devices 820, which can include without limitation a display unit, a printer and/or the like.

The computer system 800 may further include (and/or be in communication with) one or more non-transitory storage devices 825, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 800 might also include a communications subsystem 830, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 830 may permit data to be exchanged with a network (such as the network described below, to name one example), other computer systems, and/or any other devices described herein. In many embodiments, the computer system 800 may further comprise a non-transitory working memory 835, which can include a RAM or ROM device, as described above.

The computer system 800 also can comprise software elements, shown as being currently located within the working memory 835, including an operating system 840, device drivers, executable libraries, and/or other code, such as one or more application programs 845, which may comprise computer programs provided by various embodiments, and/or may be designed to implement methods, and/or configure systems, provided by other embodiments, as described herein. Merely by way of example, one or more procedures described with respect to the method(s) discussed above, for example as described with respect to FIG. 7, might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 825 described above. In some cases, the storage medium might be incorporated within a computer system, such as computer system 800. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 800 and/or might take the form of source and/or installable code, which, upon compilation and/or installation on the computer system 800 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computer system 800) to perform methods in accordance with the disclosure. For example, some or all of the procedures of the described methods may be performed by the computer system 800 in response to processor 810 executing one or more sequences of one or more instructions (which might be incorporated into the operating system 840 and/or other code, such as an application program 845) contained in the working memory 835. Such instructions may be read into the working memory 835 from another computer-readable medium, such as one or more of the storage device(s) 825. Merely by way of example, execution of the sequences of instructions contained in the working memory 835 might cause the processor(s) 810 to perform one or more procedures of the methods described herein, for example a method described with respect to FIG. 7.

The terms “machine-readable medium” and “computer-readable medium,” as used herein, refer to any medium that participates in providing data that causes a machine to operate in a specific fashion. In an embodiment implemented using the computer system 800, various computer-readable media might be involved in providing instructions/code to processor(s) 810 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 825. Volatile media include, without limitation, dynamic memory, such as the working memory 835. Transmission media include, without limitation, coaxial cables, copper wire and fiber optics, including the wires that comprise the bus 805, as well as the various components of the communications subsystem 830 (and/or the media by which the communications subsystem 830 provides communication with other devices). Hence, transmission media can also take the form of waves (including without limitation radio, acoustic and/or light waves, such as those generated during radio-wave and infrared data communications).

In one or more examples, the functions described may be implemented in hardware, software, firmware, or any combination thereof. If implemented in software, the functions may be stored on or transmitted over as one or more instructions or code on a computer-readable medium. Computer-readable media may include computer data storage media. Data storage media may be any available media that can be accessed by one or more computers or one or more processors to retrieve instructions, code and/or data structures for implementation of the techniques described in this disclosure. “Data storage media” as used herein refers to manufactures and does not refer to transitory propagating signals. By way of example, and not limitation, such computer-readable media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The code may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware stored on computer-readable media.

The term “network” and “system” may be used interchangeably herein throughout the present disclosures. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, WidebandCDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation 10 Partnership Project 2” (3GPP2). 3GPP and 3GPP2 documents are publicly available. A WLAN may include an IEEE 802.1 Ix network, and a WPAN may include a Bluetooth network, an IEEE 802.15x, for example. Such location determination techniques described herein may also be used for any combination of WWAN, WLAN, WPAN, WMAN, ancll or the like. By way of example but not limitation, a wireless broadcast system may include a MediaFLO system, a Digital TV system, a Digital Radio system, a Digital Video Broadcasting-Handheld (DVB-H) system, a Digital Multimedia Broadcasting (DMB) system, an Integrated Services Digital Broadcasting-Terrestrial (ISDB-T) system, other like systems related to broadcast techniques. Accordingly, other systems and networks may be apparent to persons having ordinary skill in the art, and embodiments are not so limited.

A SPS typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment ancllor space vehicles. In a particular example, such transmitters may be located on Earth orbiting SVs. For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation.

In accordance with certain aspects, the techniques presented herein are not restricted to global systems (e.g., GNSS) for SPS. For example, the techniques provided herein may be applied to or otherwise adapted for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise adapted for use with one or more global and/or regional navigation satellite systems. By way of example but not limitation, an SBAS may include an augmentation system(s) that provide integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Such SBAS may, for example, transmit SPS and/or SPS-like signals that may also be interfered with by certain wireless communication signals, etc. Thus, as used herein, an SPS may include any combination of one or more global and/or regional navigation satellite systems and/or augmentation systems, and SPS signals may include SPS, SPS-like, and/or other signals associated with such one or more SPS.

Signals that may be referred to in embodiments of the present invention may include GNSS signals such as GPS L1 CiA and/or L1C band signals (1575.42 MHz), GPS L2C band signals (1227.60 MHz), GPS L5 band signals (1176.45 MHz), Galileo 60 L1F band signals (1575.42 MHz), Galileo E5A band signals (1176.45 MHz), GLONASS L1 band signals (1601 MHz), Glonass L2 band signals (1246 MHz), Compass (Beidou) L1 band signals (1561 MHz, 1590 MHz), or Compass (Beidou) L2 band signals (1207 MHz). Other signals apparent to those with ordinary skill in the art may be included, and embodiments are not so limited.

Various examples have been described. These and other examples are within the scope of the following claims.

What is claimed is:

1. A method of a receiver for mitigating intermodulation (IM) distortion in a wireless communications system, comprising:
identifying at least one distortion signal that interferes with a first satellite positioning system (SPS);
maintaining reception of a first positioning channel within the first SPS; and
switching reception of a second positioning channel within the first SPS to reception of a third positioning channel within a second SPS.

2. The method of claim 1, wherein the first SPS is a victim SPS that is the subject of substantial interference.

3. The method of claim 1, wherein the second SPS is a non-victim SPS that is not subject to substantial interference.

4. The method of claim 1, wherein the first positioning channel with the first SPS is a satellite within the first SPS that is in a dedicated tracking mode.

5. The method of claim 4, wherein the first positioning channel that is in the dedicated tracking mode comprises an identification of a position of the satellite within the first SPS to a near certainty even in the presence of the at least one distortion signal.

6. The method of claim 1, wherein the second positioning channel is a satellite that is not in a dedicated tracking mode.

7. The method of claim 6, wherein the second positioning channel that is not in the dedicated tracking mode comprises a determination that a position of the satellite cannot be identified in the presence of the at least one distortion signal.

8. The method of claim 1, further comprising:
expanding a cross-correlation mask of the first SPS; and
continuing to scan for positioning channels within the first SPS that are not substantially affected by the at least one distortion signal.

9. The method of claim 1, further comprising:
conducting a scan to detect signals exhibiting cross-correlation signal characteristics; and
conducting at least one cross-correlation mitigation algorithm using the detected signals from the scan to determine which of the detected signals are cross-correlation sources and which of the detected signals are satellites in dedicated tracking mode.

10. The method of claim 9, wherein the cross-correlation sources comprise at least one of a satellite that is within a line-of-sight view of the receiver, and a satellite having a strong signal and is not within the line-of-sight view of the receiver.

11. The method of claim 9, wherein conducting the at least one cross-correlation mitigation algorithm comprises at least one of: widening an existing cross-correlation mask, and checking for IM distortion-related cross-correlation signals.

12. The method of claim 8, wherein conducting the scan further comprises adding an activity pin that detects wireless transmissions causing IM distortion.

13. The method of claim 1, further comprising:
determining the at least one distortion signal to grossly interfere with the first SPS;
determining the at least one distortion signal to mildly interfere with the second SPS; and
performing a remedial measure such that the interference of the second SPS by the at least one distortion signal is substantially reduced.

14. The method of claim 13, wherein the remedial measure comprises shifting a local oscillator (LO) frequency.

15. The method of claim 1, further comprising:
determining the at least one distortion signal to grossly interfere with both the first SPS and the second SPS; and
switching at least one receiver from an operational state to an idle state.

16. An apparatus for mitigating intermodulation (IM) distortion in a wireless communications system, comprising:
a receiver configured to receive at least one distortion signal that interferes with a first satellite positioning system (SPS); and
maintain reception of a first positioning channel within the first SPS; and
a processor configured to switch reception of the receiver from a second positioning channel within the first SPS to reception of a third positioning channel within a second SPS.

17. The apparatus of claim 16, wherein the first SPS is a victim SPS that is the subject of substantial interference.

18. The apparatus of claim 16, wherein the second SPS is a non-victim SPS that is not subject to substantial interference.

19. The apparatus of claim 16, wherein the first positioning channel with the first SPS is a satellite within the first SPS that is in a dedicated tracking mode.

20. The apparatus of claim 19, wherein the first positioning channel that is in the dedicated tracking mode comprises an identification of a position of the satellite within the first SPS to a near certainty even in the presence of the at least one distortion signal.

21. The apparatus of claim 16, wherein the second positioning channel is a satellite that is not in a dedicated tracking mode.

22. The apparatus of claim 21, wherein the second positioning channel that is not in the dedicated tracking mode comprises a determination that a position of the satellite cannot be identified in the presence of the at least one distortion signal.

23. The apparatus of claim 16, wherein the processor is further configured to:
expand a cross-correlation mask of the first SPS; and
continue to scan for positioning channels within the first SPS that are not substantially affected by the at least one distortion signal.

24. The apparatus of claim 16, wherein the processor is further configured to:
conduct a scan to detect signals exhibiting cross-correlation signal characteristics; and
conduct at least one cross-correlation mitigation algorithm using the detected signals from the scan to determine which of the detected signals are cross-correlation sources and which of the detected signals are satellites in dedicated tracking mode.

25. The apparatus of claim 23, wherein the cross-correlation sources comprise at least one of a satellite that is within a line-of-sight view of the receiver, and a satellite having a strong signal and is not within the line-of-sight view of the receiver.

26. The apparatus of claim 24, wherein conducting the at least one cross-correlation mitigation algorithm comprises at least one of: widening an existing cross-correlation mask, and checking for IM distortion-related cross-correlation signals.

27. The apparatus of claim 23, wherein conducting the scan further comprises adding an activity pin that detects wireless transmissions causing IM distortion.

28. The apparatus of claim 16, wherein the processor is further configured to:
determine the at least one distortion signal to grossly interfere with the first SPS;
determine the at least one distortion signal to mildly interfere with the second SPS; and
perform a remedial measure such that the interference of the second SPS by the at least one distortion signal is substantially reduced.

29. The apparatus of claim 28, wherein the remedial measure comprises shifting a local oscillator (LO) frequency.

30. The apparatus of claim 16, wherein the processor is further configured to:
determine the at least one distortion signal to grossly interfere with both the first SPS and the second SPS; and
switch the receiver from an operational state to an idle state.

31. An apparatus for mitigating intermodulation (IM) distortion in a wireless communications system, comprising:
means for identifying at least one distortion signal that interferes with a first satellite positioning system (SPS);
means for maintaining reception of a first positioning channel within the first SPS; and
means for switching reception of a second positioning channel within the first SPS to reception of a third positioning channel within a second SPS.

32. The apparatus of claim 31, wherein the first positioning channel with the first SPS is a satellite within the first SPS that is in a dedicated tracking mode.

33. The apparatus of claim 32, wherein the first positioning channel that is in the dedicated tracking mode comprises an identification of a position of the satellite within the first SPS to a near certainty even in the presence of the at least one distortion signal.

34. The apparatus of claim 31, further comprising:
means for expanding a cross-correlation mask of the first SPS; and
means for continuing to scan for positioning channels within the first SPS that are not substantially affected by the at least one distortion signal.

35. The apparatus of claim 31, further comprising:
means for conducting a scan to detect signals exhibiting cross-correlation signal characteristics; and
means for conducting at least one cross-correlation mitigation algorithm using the detected signals from the scan to determine which of the detected signals are cross-correlation sources and which of the detected signals are satellites in dedicated tracking mode.

36. The apparatus of claim 35, wherein the means for conducting the at least one cross-correlation mitigation algorithm comprises at least one of: means for widening an existing cross-correlation mask, and means for checking for IM distortion-related cross-correlation signals.

37. The apparatus of claim 34, wherein the means for conducting the scan further comprises means for adding an activity pin that detects wireless transmissions causing IM distortion.

38. The apparatus of claim 31, further comprising:
means for determining the at least one distortion signal to grossly interfere with the first SPS;
means for determining the at least one distortion signal to mildly interfere with the second SPS; and
means for performing a remedial measure such that the interference of the second SPS by the at least one distortion signal is substantially reduced.

39. The apparatus of claim 38, wherein the remedial measure comprises shifting a local oscillator (LO) frequency.

40. The apparatus of claim 31, further comprising:
means for determining the at least one distortion signal to grossly interfere with both the first SPS and the second SPS; and
means for switching at least one receiver from an operational state to an idle state.

41. A computer program product for mitigating intermodulation (IM) distortion in a wireless communications system, the computer program product residing on a processor-readable medium and comprising processor-readable instructions configured to cause a processor to:
receive at least one distortion signal that interferes with a first satellite positioning system (SPS);
maintain reception of a first positioning channel within the first SPS; and
switch reception of a receiver from a second positioning channel within the first SPS to reception of a third positioning channel within a second SPS.

42. The computer program product of claim 41, wherein the instructions further cause the processor to:
expand a cross-correlation mask of the first SPS; and
continue to scan for positioning channels within the first SPS that are not substantially affected by the at least one distortion signal.

43. The computer program product of claim 41, wherein the instructions further cause the processor to:
conduct a scan to detect signals exhibiting cross-correlation signal characteristics; and
conduct at least one cross-correlation mitigation algorithm using the detected signals from the scan to determine which of the detected signals are cross-correlation sources and which of the detected signals are satellites in dedicated tracking mode.

44. The computer program product of claim 41, wherein the instructions further cause the processor to:
determine the at least one distortion signal to grossly interfere with the first SPS;
determine the at least one distortion signal to mildly interfere with the second SPS; and
perform a remedial measure such that the interference of the second SPS by the at least one distortion signal is substantially reduced.

45. The computer program product of claim 44, wherein the remedial measure comprises shifting a local oscillator (LO) frequency.

46. The computer program product of claim 41, wherein the instructions further cause the processor to:
determine the at least one distortion signal to grossly interfere with both the first SPS and the second SPS; and
switch the receiver from an operational state to an idle state.
